(19) United States
(12) Patent Application Publication
(10) Pub. No.: US 2016/0102429 A1
(43) Pub. Date: Apr. 14, 2016

(54) Carpet Backing Compositions and Carpet Backing Comprising the Same

(71) Applicant: EXXONMOBIL CHEMICAL PATENTS INC., Baytown, TX (US)

(72) Inventors: Eugene R. Uhl, Massillon, OH (US); Felix M. Zacarias, Houston, TX (US); Charles P. Siskovich, Massillon, OH (US); Randal H. Kerstetter, III, Wadsworth, OH (US); Daniel J. Collins, Akron, OH (US); Ernest R. Anderson, Garretsville, OH (US)

(21) Appl. No.: 14/889,390

(22) PCT Filed: Jun. 19, 2014
(86) PCT No.: PCT/US2014/043150

§ 371 Date: Nov. 5, 2015

Related U.S. Application Data
(60) Provisional application No. 61/842,231, filed on Jul. 2, 2013.

(51) Int. Cl. D06N 7/00; C08L 23/26

(52) U.S. Cl. CPC D06N 7/0076; C08L 23/26; D06N 2203/042

(57) ABSTRACT

The present disclosure relates to a carpet backing composition comprising a first polymer component, a filler, and a compatibilizer that can provide free radial resource for performing bonding functions of the first polymer component and the filler. The composition can exhibit good melt strength/extrudability and low viscosity. The present disclosure also relates to a carpet backing or a carpet that comprises such carpet backing composition.

### CROSS REFERENCE TO RELATED APPLICATIONS

This application claims the benefit of priority to U.S. Provisional Application No. 61/842,231, filed Jul. 2, 2013, the disclosure of which is fully incorporated herein by reference.

### FIELD OF THE INVENTION

The present disclosure relates to a composition that can be used in carpet backing, in particular to a composition comprising a first polymer component, a filler, and a compatibilizer that can bind the first polymer component and the filler. The present disclosure also relates to a carpet backing comprising such composition.

### BACKGROUND OF THE INVENTION

Most conventional carpets comprise a primary backing with fiber tufts in the form of cut or uncut loops extending upwardly from the backing to form a pile surface. In the case of tufted carpets, the fibers are tufted into a primary backing layer and then a secondary backing layer is applied thereto. Additional backing layers can be optionally attached to the secondary backing layer.

U.S. Patent Application Publication Nos. 2007/095453 A1, 2008/0280093 A1, and 2011/0256335 A1 disclose a carpet and the method of making it. The carpet includes (a) a primary backing which has a face and a back surface, (b) a plurality of fibers attached to the primary backing and extending from the face of the primary backing and exposed at the back surface of the primary backing, (c) an adhesive backing, (d) an optional secondary backing adjacent to the adhesive backing, and (e) at least one homogeneously branched linear ethylene polymer. The method includes extrusion coating at least one homogeneously branched linear ethylene polymer onto the back surface of a primary backing to provide an adhesive backing. Additional steps and procedures include preheating the primary backing prior the extrusion step, multilayer adhesive backings, washing or scouring the primary backing prior the extrusion step, and utilizing adhesive polymeric additives, high heat content fillers, blowing agents and/or implosion agents.

U.S. Patent Application Publication No. 2014/0017439 describes carpets comprising a propylene-based copolymer, and method of making the same. The presence of the propylene-based copolymer provides the carpet with improved properties, including good tuft bind strength and tuft lock strength, and reliable construction.

In order to properly flow around the tufted carpet fibers to form a secure bond between the carpet fibers, the primary backing layer and the second backing layer, carpet backing compositions are preferred to have a high flow rate or a low viscosity.

One way to increase the flowablity of the carpet backing composition is to include a polymer component having a higher melt flow rate (MFR) in the carpet backing composition. However, such polymer components normally have low molecular weight and low melt strength, which may result in breakage of the extruded sheet of the molten or semi-molten carpet backing composition during continuous extrusion. Accordingly, it is difficult to meet both good flowability and melt strength of carpet backing compositions. Similar difficulties remain in heavy layer mat backings as well.

Other desirable properties of carpet backing or heavy layer mat backing compositions include flexural modulus or “stiffness” and moisture level of undried neat pellets.

Therefore there is need to develop a carpet backing composition that have both flow ability and melt strength/extrudability, as well as desirable stiffness and moisture level. There is also a need for such compositions that are capable of further comprising small amounts of high flow rate polymer components, and still exhibit low viscosity and high melt strength/extrudability.

### SUMMARY OF THE INVENTION

It is an object of the present disclosure to provide a composition that can be used in carpet backing applications and can exhibit both low viscosity and high melt strength. In preferred embodiments, the composition also exhibits desirable flexural modulus and moisture level properties.

In one aspect the present disclosure provides a composition comprising: (a) about 10 wt % to about 50 wt % of a first polymer component by weight of the composition, the first polymer component comprising about 60 wt % to about 98 wt % of units derived from ethylene or propylene and about 2 wt % to about 40 wt % of units derived from at least one of ethylene and C₃-C₁₂ alpha-olefin comonomers, and having a density of from about 0.850 g/cm³ to about 0.915 g/cm³; (b) about 50 wt % to about 90 wt % of a filler by weight of the composition; and (c) about 0.1 wt % to about 5 wt %, or of a compatibilizer by weight of the composition, the compatibilizer providing free radical source to bond the first polymer component and the filler.

In some embodiments, the compatibilizer may be present in an amount of about 0.1 wt % to about 3 wt % by weight of the composition. In preferred embodiments the compatibilizer provides a free radical source through ion mechanism initiated by hydrolysis reaction to bond the polymers and the fillers.

In some embodiments, the composition may also comprise about 0.1 wt % to about 10 wt % a second polymer composition having a melt flow rate, as determined by DSC, of about 250 g/10 min or greater, where the first polymer component has a melt flow rate of about 200 g/10 min or less.

In some embodiments, the second polymer component comprises a hydrocarbon tackifying resin, preferably an aromatic modified hydrocarbon tackifying resin.

In another aspect the present disclosure provides a carpet backing or a heavy layer mat backing that comprises the compositions disclosed herein. In still another aspect the present disclosure provides a carpet or a heavy layer mat comprising such backings.

### DETAILED DESCRIPTION OF THE INVENTION

The present disclosure relates to a composition comprising a first polymer component, one or more fillers, and a compatibilizer for bonding the first polymer components and fillers. The composition provides enhanced balance of extrudability and physical properties useful in backing applications.

The composition comprises a first polymer component from a lower limit of about 10 wt %, about 15 wt %, or about 20 wt % to an upper limit of about 50 wt %, about 40 wt %, about 30 wt %, or about 20 wt % by weight of the composition, where desirable ranges may include ranges from any lower limit to any upper limit so long as the value of the lower limit is smaller than the upper limit.

The composition comprises a filler from a lower limit of about 50 wt %, about 55 wt %, about 60 wt %, or about 65 wt % to an upper limit of about 90 wt %, about 85 wt %, 80 wt %, or about 75 wt % by weight of the composition, where desirable ranges may include ranges from any lower limit to any upper limit so long as the value of the lower limit is smaller than the upper limit.

The composition comprises a compatibilizer from a lower limit of about 0.1 wt %, about 0.5 wt %, about 1 wt %, or about 1.5 wt % to an upper limit of about 5 wt %, about 4 wt %, about 3 wt %, or about 2 wt % by weight of the composition, where desirable ranges may include ranges from any lower limit to any upper limit so long as the value of the lower limit is smaller than the upper limit.

The composition may further comprise a second polymer component from a lower limit of about 0.1 wt %, about 0.5 wt %, about 1 wt %, or about 1.5 wt % to an upper limit of about 10 wt %, about 5 wt %, about 4 wt %, about 3 wt %, or about 2 wt % by weight of the composition, where desirable ranges may include ranges from any lower limit to any upper limit. In some embodiments, the second polymer component has high melt flow rate, for example, of about 250 g/10 min, or greater, when the first polymer component has a relatively low melt flow rate, for example, of about 200 g/10 min or less.

### First Polymer Component

The first polymer component can be any elastomeric polyolefin polymer. As used herein, the term “polymer” is meant to encompass homopolymers and copolymers; the term “copolymer” includes any polymer having two or more monomers or comonomers.

As used herein the term “elastomeric” or “elastomeric polymer” is meant to encompass elastomers and plastomers that exhibit elasticity consistent with the ASTM D1566 definition. Elastomer includes mixed blends of polymers such as melt mixing and/or reactor blends of polymers.

In one embodiment, the elastomeric polyolefin polymers can be copolymers of ethylene and an alpha-olefin, for example, a C₃-C₁₂ alpha-olefin. Suitable alpha-olefins may be linear or branched (e.g., one or more C₁-C₃ alkyl branches, or an aryl group). Specific examples include propylene; 1-butene; 3-methyl-1-butene; 3,3-dimethyl-1-butene; 1-pentene; 1-pentene with one or more methyl, ethyl or propyl substituents; 1-hexene; 1-hexene with one or more methyl, ethyl or propyl substituents; 1-heptene; 1-heptene with one or more methyl, ethyl or propyl substituents; 1-octene; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired alpha-olefin comonomers are propylene; 1-butene, 1-hexene and 1-octene.

The ethylene or propylene content of such copolymers may be from about 60 wt % to about 98 wt %, or from about 70 wt % to about 95 wt %, or from about 75 wt % to about 92.5 wt %. The alpha-olefin content may likewise range from about 2 wt % to about 40 wt %, or from about 5 wt % to about 30 wt %, or from about 7.5 wt % to about 25 wt %.

The density of a linear olefin copolymer is generally a function of both the length and amount of the alpha-olefin. That is, the greater the length of the alpha-olefin and the greater the amount of alpha-olefin present, the lower the density of the copolymer. In some embodiments, the density of the first polymer component may be about 0.915 g/cm³ or less, for example, from about 0.850 to about 0.915 g/cm³, or from about 0.855 to about 0.895 g/cm³.

In some embodiments, the first polymer component has a melt flow rate of about 200 g/10 min or less, or about 175 g/10 min or less, or about 150 g/10 min or less. The MFR is determined according to ASTM D-1238, condition L (21.6 kg, 230° C.).

In some embodiments, the first polymer component is a propylene-based copolymer or an ethylene-based copolymer as described in further detail below.

### Propylene-Based Copolymer

The propylene-based copolymer that can be used can be a random copolymer having crystalline regions interrupted by non-crystalline regions, and can be referred as “propylene-based elastomer” herein. Not intended to be limited by any theory, it is believed that the non-crystalline regions may result from regions of non-crystallizable polypropylene segments and/or the inclusion of comonomer units. The crystallinity and the melting point of the propylene-based copolymer are reduced compared to highly isotactic polypropylene by the introduction of errors (stereo and region defects) in the insertion of propylene and/or by the presence of comonomer.

The propylene-based copolymer can comprise propylene-derived units and units derived from at least one of ethylene or a C₄-C₁₂ alpha-olefin, and optionally, a diene-derived unit. The copolymer contains at least about 60 wt % propylene-derived units by weight of the propylene-based copolymer. In some embodiments, the propylene-based copolymer is a propylene-based copolymer having limited crystallinity due to adjacent isotactic propylene units and a melting point as described herein. In other embodiments, the propylene-based copolymer is generally devoid of any substantial intermolecular heterogeneity in tacticity and comonomer composition, and also generally devoid of any substantial heterogeneity in intramolecular composition distribution.

The propylene-based copolymer can contain greater than about 60 wt %, or greater than about 65 wt %, or greater than about 75 wt % and up to about 98 wt % propylene-derived units, based on the total weight of the propylene-based copolymer. In some embodiments, the propylene-based copolymer includes propylene-derived units in an amount based on the weight of propylene-based copolymer of from about 75 wt % to about 95 wt %, or from about 75 wt % to about 92.5 wt %, or from about 82.5 wt % to about 92.5 wt %. Correspondingly, the units derived from at least one of ethylene or a C₄-C₁₀ alpha-olefin may be present in an amount of about 1 wt % to about 40 wt %, or from about 5 wt % to about 25 wt %, or from about 7.5 wt % to about 20 wt %, or from about 7.5 wt % to about 17.5 wt %, or from about 10 wt % to 17.5 wt %, based on the weight of the propylene-based copolymer.

In some embodiments, diene comonomer units can be included in the propylene-based copolymer. Examples of the diene include, but are not limited to, 5-ethylidene-2-norbornene, 5-vinyl-2-norbornene, divinyl benzene, 1,4-hexadiene, 5-methylene-2-norbornene, 1,6-octadiene, 5-methyl-1,4-hexadiene, 3,7-dimethyl-1,6-octadiene, 1,3-cyclopentadiene, 1,4-cyclohexadiene, dicyclopentadiene, or a combination thereof. The amount of diene comonomer is equal to or more than 0 wt %, or 0.5 wt %, or 1 wt %, or 1.5 wt % and lower than, or equal to, 5 wt %, or 4 wt %, or 3 wt % or 2 wt %, based on the weight of propylene-based copolymer, where desirable ranges may include ranges from any lower limit to any upper limit.

The propylene-based copolymer can have a heat of fusion (“H_{f}”), as determined by the Differential Scanning calorimetry (“DSC”), of about 75 J/g or less, or about 70 J/g or less, or about 50 J/g or less, or about 35 J/g or less. The propylene-based copolymer may have a lower limit H_{f} of about 0.5 J/g, or about 1 J/g, or about 5 J/g. For example, the H_{f} value may be anywhere from 1, 1.5, 3, 4, 6, or 7 J/g, to 30, 35, 40, 50, 60, 70, or 75 J/g, where desirable ranges may include ranges from any lower limit to any upper limit.

The propylene-based copolymer can have a percent crystallinity, as determined according to the DSC procedure described herein, of about 2% to about 65%, preferably about 0.5% to about 40%, or about 1% to about 30%, or about 5% to about 35%, of isotactic polypropylene. The thermal energy for the highest order of propylene (i.e., 100% crystallinity) is estimated at 189 J/g. In some embodiments, the copolymer has a crystallinity in the range of about 0.25% to about 25%, or about 0.5% to about 22% of isotactic polypropylene.

In some embodiments, the propylene-derived units of the propylene-based copolymer can have an isotactic triad fraction of about 50% to about 99%, or about 65% to about 97%, or about 75% to about 97%. In other embodiments, the first polymer has a triad tacticity as determined by ¹³C NMR, of about 75% or greater, about 80% or greater, about 82% or greater, about 85% or greater, or about 90% or greater.

The triad tacticity of a polymer is the relative tacticity of a sequence of three adjacent propylene units, a chain consisting of head to tail bonds, expressed as a binary combination of m and r sequences. It is usually expressed as the ratio of the number of units of the specified tacticity to all of the propylene triads in the first polymer. The triad tacticity (mm fraction) of a propylene copolymer can be determined from a ¹³C NMR spectrum of the propylene copolymer. The calculation of the triad tacticity is described in the U.S. Pat. No. 5,504,172, the entire contents of which is incorporated herein by reference.

The propylene-based copolymer may have a single peak melting transition as determined by DSC. However, the copolymer may show secondary melting peaks adjacent to the principal peak, and/or at the end-of-melt transition. For the purposes of this disclosure, such secondary melting peaks are considered together as a single melting point, with the highest of these peaks being considered the melting temperature (“Tm”) of the propylene-based copolymer. The propylene-based copolymer may have a Tm of about 110° C. or less, about 100° C. or less, about 90° C. or less, about 80° C. or less, or about 70° C. or less. In one embodiment, the propylene-based copolymer has a Tm of about 25° C. to about 100° C., about 25° C. to about 85° C., about 25° C. to about 75° C., or about 25° C. to about 65° C., where desirable ranges may include ranges from any lower limit to any upper limit. In some embodiments, the propylene-based copolymer has a Tm of about 30° C. to about 80° C., preferably about 30° C. to 70° C.

Differential scanning calorimetric (“DSC”) data is obtained using a Perkin-Elmer DSC 7. About 5 mg to about 10 mg of a sheet of the polymer to be tested is pressed at approximately 200° C. to 230° C., then removed with a punch die and annealed at room temperature for 48 hours. The samples are then sealed in aluminum sample pans. The DSC data are recorded by first cooling the sample to −50° C. and then gradually heating it to 200° C. at a rate of 10° C./minute. The sample is kept at 200° C. for 5 minutes before a second cooling-heating cycle was applied. Both the first and second cycle thermal events are recorded. Areas under the melting curves are measured and used to determine the heat of fusion and the degree of crystallinity. The percent crystallinity (X %) can be calculated using the formula, X %=[area under the curve (Joules/gram)/B (Joules/gram)]*100, where B is the heat of fusion for the homopolymer of the major monomer component. These values for B can be found from the Polymer Handbook, Fourth Edition, published by John Wiley and Sons, New York 1999. A value of 189 J/g (B) is used as the heat of fusion for 100% crystalline polypropylene. The melting temperature is measured and reported during the second heating cycle (or second melt).

In one or more embodiments, the propylene-based copolymer can have a Mooney viscosity [ML (1+4) @ 125° C.], as determined according to ASTM D-1646, of less than 100, or less than 75, or less than 60, or less than 30.

The propylene-based copolymer can have a density of about 0.850 g/cm³ to about 0.915 g/cm³, about 0.860 g/cm³ to about 0.900 g/cm³, or about 0.860 g/cm³ to about 0.890 g/cm³, at room temperature as determined per ASTM D-1505.

The propylene-based copolymer can have a melt flow rate (“MFR”) greater than 0.5 g/10 min, and less than or equal to 200 g/10 min, more preferably less than or equal to about 100 g/10 min, more preferably less than or equal to about 50 g/10 min Particularly preferred embodiments include a propylene-based copolymer with an MFR of less than or equal to about 45 g/10 min, such as from about 1 to about 45 g/10 min, or from 1 to about 30 g/10 min. The MFR is determined according to ASTM D-1238, condition L (21.6 kg, 230° C.).

The propylene-based copolymer can have a weight average molecular weight (“Mw”) of about 5,000 to about 5,000,000 g/mole, or about 10,000 to about 1,000,000 g/mole, or about 50,000 to about 400,000 g/mole. The propylene-based copolymer can have a number average molecular weight (“Mn”) of about 2,500 to about 2,500,00 g/mole, or about 10,000 to about 250,000 g/mole, or about 25,000 to about 200,000 g/mole. The propylene-based copolymer can have a z-average molecular weight (“Mz”) of about 10,000 to about 7,000,000 g/mole, or about 80,000 to about 700,000 g/mole, or about 100,000 to about 500,000 g/mole. The propylene-based copolymer may have a molecular weight distribution (“MWD”) of about 1.5 to about 20, or about 1.5 to about 15, or about 1.5 to about 5, or about 1.8 to about 5, or about 1.8 to about 4.

The propylene-based copolymer may have an Elongation at Break of less than about 2000%, less than about 1000%, or less than about 800%, as determined per ASTM D412.

This disclosure is not limited by any particular polymerization method for preparing the propylene-based copolymer. General process conditions may be found in U.S. Pat. No. 5,001,205, PCT publications WO 96/33227 and WO 97/22639, entire content U.S. Pat. Nos. 4,543,399, 4,588,790, 5,028,670, 5,317,036, 5,352,749, 5,405,922, 5,436,304, 5,453,471, 5,462,999, 5,616,661, 5,627,242, 5,665,818, 5,668,228, and 5,677,375, and European publications EP-A-0 794 200, EP-A-0 802 202 and EP-B-634 421, the entire contents of which are incorporated herein by reference.

Examples of propylene-based copolymers can be available commercially under the trade names Vistamaxx™ (ExxonMobil Chemical Company, Houston, Tex., USA) and Versify™ (The Dow Chemical Company, Midland, Mich., USA), certain grades of Tafmer™ or Notio™ (Mitsui Company, Japan), Softel™ (Basell Polyolefins of the Netherlands), and FINA™ from Atofina Chemicals of Feluy, Belgium. Other examples of suitable propylene polymers are described in U.S. Pat. No. 6,500,563 to Datta, et al.; U.S. Pat. No. 5,539,056 to Yang, et al.; and U.S. Pat. No. 5,596,052 to Resconi, et al., which are incorporated herein in their entirety by reference thereto for all purposes.

### Ethylene-Based Copolymer

The ethylene-based copolymer useful in the present disclosure can include ethylene-derived units in an amount based on the weight of ethylene-based copolymer of from about 60 wt % to about 98 wt %, or from 65 wt % to about 95 wt %, or from about 70 wt % to about 95 wt %, or from about 75 wt % to about 85 wt %, or from 70 wt % to about 80 wt %. Correspondingly, the units derived from at least one of a C₃-C₁₂ alpha-olefin may be present in an amount of about 2 wt % to about 40 wt %, or about 5 wt % to about 35 wt %, or about 5 wt % to about 30 wt %, or from about 15 wt % to about 25 wt %, or from about 20 wt % to about 30 wt %, based on the weight of the ethylene-based copolymer.

The ethylene-based copolymers can have a density of from about 0.850 g/cm³ to about 0.915 g/cm³, or from about 0.855 g/cm³ to about 0.910 g/cm³, or from about 0.860 g/cm³ to about 0.895 g/cm³.

The ethylene-based copolymer can have a melt index (MI), as determined by ASTM D1238 at 190° C., 2.1 kg, of between 0.1 g/10 min and 20 g/10 min, or from 0.2 g/10 min to 10 g/10 min, or from 0.3 g/10 min to 8 g/10 min.

The ethylene-based copolymer can have an average molecular weight of from 10,000 to 800,000 or from 20,000 to 700,000.

The ethylene-based copolymer can have a 1% secant flexural modulus, as determined by ASTM D790, of from about 10 MPa to about 150 MPa, or from about 20 MPa to about 100 MPa.

The ethylene-based copolymer can have a melting temperature (Tm) of from 50° C. to 62° C. (first melt peak) and from 65° C. to 85° C. (second melt peak), or from 52° C. to 60° C. (first melt peak) and from 70° C. to 80° C. (second melt peak).

Ethylene-based copolymer useful in the present invention can be metallocene catalyzed copolymers of ethylene derived units and higher alpha-olefin derived units such as propylene, 1-butene, 1-hexene and 1-octene, and which contain enough of one or more of these comonomer units to yield a density between 0.860 and 0.900 g/cm3. The molecular weight distribution (Mw/Mn) of desirable plastomers ranges from 2 to 5, or from 2.2 to 4.

Examples of a commercially available ethylene-based copolymer are EXACT™ 4150, a copolymer of ethylene and 1-hexene, the 1-hexene derived units making up from 18 to 22 wt % of the plastomer and having a density of 0.895 g/cm3 and MI of 3.5 dg/min (ExxonMobil Chemical Company, Houston, Tex.); and EXACT™ 8201, a copolymer of ethylene and 1-octene, the 1-octene derived units making up from 26 to 30 wt % of the plastomer, and having a density of 0.882 g/cm3 and MI of 1 dg/min (ExxonMobil Chemical Company, Houston, Tex.). Other suitable ethylene-based copolymers are available under the designation ENGAGE™ and AFFINITY™ from Dow Chemical Company of Midland, Mich.

### Compatibilizer

The compatibilizer that can be used in present disclosure includes those that can provide a free radical source to bond organic and inorganic materials. In one embodiment, the free radical source is provided through ionic mechanism initiated by hydrolysis reaction during heating or mixing of the elastomeric copolymer and the filler.

The compatibilizer can have a melting point of greater than 50° C., for example, from about 50° C. to about 120° C., or from about 60° C. to about 90° C.

The compatibilizer can have a flash point of greater than 150° C., for example, from about 150° C. to about 300° C., or from about 180° C. to about 250° C., or from about 200° C. to about 250° C.

In some embodiments, the compatibilizer can have specific gravity of from about 0.90 g/cm³ to about 1 g/cm³, or from about 0.93 g/cm³ to about 1 g/cm³, or from about 0.95 g/cm³ to about 0.99 g/cm³.

The compatibilizer can be in a form of powder or pastille and can be dissolved in an organic solution, such as acetone.

Examples of useful compatibilizers include STRUKTOL® TPW 243, and STRUKTOL® TPW 244 commercially available from Struktol Company of America, Ohio, U.S.

### Filler

Suitable fillers can be organic fillers and/or inorganic fillers. Suitable fillers include such materials as carbon black, fly ash, graphite, cellulose, starch, polyester-based material, and polyamide-based materials, etc. Preferred examples of fillers are calcium carbonate, aluminum trihydrate, talc, glass fibers, marble dust, cement dust, clay, feldspar, silica or glass, fumed silica, alumina, magnesium oxide, antimony oxide, zinc oxide, barium sulfate, calcium sulfate, aluminum silicate, calcium silicate, titanium dioxide, titanates, clay, nanoclay, organo-modified clay or nanoclay, glass microspheres, and chalk. Fillers improving flame retardant properties, such as aluminum trihydrate, are mostly preferred in some embodiments. Particular useful fillers in the present disclosure include fly ash, ground glass, calcium carbonate, talc, and clay.

In some embodiments, two or more fillers can be used. For example, fly ash and glass are preferred to be used together in carpet backing applications. Other combinations of fillers can vary from needs.

### Second Polymer Component

The composition may further comprise a second polymer component. In some embodiments, the second polymer component may comprise a propylene-based copolymer as described above, and may have a melt flow weight, as determined by 230° C. and 2.16 kg weight, of about 10 g/10 min.

In other embodiments, the second polymer component may have a melt flow rate (MFR) of about 250 g/10 min or greater. In such embodiments, the first polymer component may have a melt flow rate of about 200 g/10 min or less. The second polymer component can be a homo-polymer, such as a functionalized/modified homo-polymer, a copolymer, such as a functionalized/modified copolymer, an oligomer, a hydrocarbon tackifying resin, such as a functionalized/modified hydrocarbon tackifying resin, or any combinations thereof. The second polymer component can have 2 to 40, typically 2 to 12 carbon atoms. Illustrative, non-limiting examples of such second polymer component include homo-polymers, copolymers, and oligomers of ethylene, propylene, butadiene, isoprene, isobutylene, hexene, octene, the like, and mixtures thereof. In one embodiment, the second polymer component can contain a maleic anhydride functionalized polyolefin, for example, a maleic anhydride functionalized polypropylene. In another embodiment, the second polymer component can contain an aromatic functionalized/modified hydrocarbon tackifying resin.

Preferably the second polymer component can have a melt flow rate, for example, of about 300 g/10 min or greater, or about 500 g/10 min or greater, or about 800 g/10 min or greater, or about 1000 g/10 min or greater. The Melt Flow rate can be determined according to ASTM D-1238 at 230° C., 2.16 kg.

Preferably the second polymer component can have a molecular weight Mw of 100 to 20,000, or from 500 to 15,000, or from 1,000 to 10,000.

Illustrative, non-limiting examples of the second polymer component include polyethylene, maleated polyethylene, maleated metallocene polyethylene, such as EXCEED™ resins available from ExxonMobil Chemical Company in Houston, Tex., U.S., polypropylene, maleated polypropylene, maleated metallocene polypropylene, such as ACHIEVE™ resins available from ExxonMobil Chemical Company in Houston, Tex., U.S., ethylene propylene copolymer, maleated ethylene propylene copolymer, maleated polypropylene, maleated ethylene copolymers, such as EXXELOR™ polymer resins available from ExxonMobil Chemical Company in Houston, Tex., U.S., functionalized polyisobutylene, aromatically modified polyolefin resin, such as Escorez™ tackifying resins available from ExxonMobil Chemical Company in Houston, Tex., U.S., and Wingtack™ hydrocarbon resin, available from Cray Valley USA, LLC, Exton, Pa., U.S.

### Other Additives

As will be evident to those skilled in the art, the polymer compositions of the present disclosure may comprise other additives, in addition to the first polymer component, filler, compatibilizer and optionally the second polymer component, to adjust the characteristics of the composition as desired. Various additives may be incorporated to enhance a specific property or may be incorporated as a result of processing of the individual components. Additives which may be incorporated include, but are not limited to, processing oils, processing aids, fire retardants, antioxidants, flow improvers, coloring agents, reinforcements, and adhesive additives.

The compositions may contain processing oils and processing aids. Paraffinic oil, naphthenic oil or polyalphaolefin (PAO) fluid are suitable processing oils for use in the composition of present disclosure. The processing oil can be present in an amount of up to 10 wt %, or from about 0.1 wt % to about 10 wt %, or from about 0.5 wt % to about 8 wt %, or from about 1 wt % to about 5 wt %, by weight of the composition. Additional processing aids include waxes, fatty acid salts, such as calcium stearate or zinc stearate, alcohols, including glycols, glycol ethers, alcohol ether, (poly) esters including (poly)glycol esters and salts to one particular ethnic group or two metal or zinc salt derivatives.

The compositions may further contain an adhesive additive that can facilitate the bonding of the extruded composition with the primary layer and the tufted carpet fibers. Useful bonding agent comprises maleic anhydride functionalized ethylene vinyl acetate (EVA). When employed, the adhesive additives can be present in an amount of up to 10 wt %, or from about 0.1 wt % to about 10 wt %, or from about 1 wt % to about 8 wt %, or from about 1 wt % to about 5 wt %, based on the weight of the composition.

The compositions may contain a heat stabilizer and/or antioxidant. Hindered amine stabilizers, e.g., CHIMASSORB™ available from Ciba Specialty Chemicals, are exemplary heat and light stabilizers. Further, hindered phenols can be used as an antioxidant. Some suitable hindered phenols include those available from Ciba Specialty Chemicals of under the trade name Irganox™. When employed, the antioxidant and/or the stabilizer, may each be present in an amount of up to about 20 wt %, for example, from about 0.1 wt % to about 20 wt %, or from about 0.5 wt % to about 15 wt %, or from 1 wt % to about 10 wt %, by weight of the composition.

### Making the Polymer Composition

The polymer compositions according to this disclosure may be compounded by any known method. For example, the compounding may be carried out in a continuous mixer such as a Brabender mixer, a mill or an internal mixer such as Banbury mixer. The compounding may also be conducted in a continuous process such as a twin screw extruder.

In some embodiments, the first polymer component, the filler, the compatibilizer, and optionally the second polymer component and/or other additives can be pre-blended and then fed to an extruder for melt-mixing. In some other embodiments, the first polymer component, the filler, the compatibilizer, and optionally, the second polymer component and/or other additives can be fed separately to an extruder and melt-mix them in the extruder.

Preferably, when the compatibilizer is separately fed, it can be added at the feed throat of an extruder. Optimum results can be obtained by having adequate venting atmospheric and vacuum in some zones of the extruder so degassing will occur in the feed throat. Preferably, the fillers can be added after sufficient molten-state mixing of the polymer components and the compatibilizer.

The composition can be made in extruders with one or more screws, or extruders of co- or counter-rotating type of screws. The type and intensity of mixing, temperature, and residence time required can be achieved by the choice of one of the above machines in combination with the selection of mixing elements, screw design, and screw speed.

Typically, a pyramid temperature profile is preferred when making the composition using an extruder. In the first few zones of the extruder, the temperature can be from 10° C. to 190° C., and 190° C. to 250° C. in the intermediate few zones, and 120° C. to 180° C. in the last few zones. The temperature in the die can be from 200° C. to 350° C. The residence time in the extruder can be from 10 to 60 minutes.

When the composition comprises other additives, the additives can be introduced into the polymer composition at the same time as the other components or later at downstream in case of using an extruder or Buss kneader or only later in time. For example, a processing oil can be added in one addition or in multiple additions.

In some embodiments, the composition made can have at least one of the following properties:

a viscosity @ 1/200 s of less than about 600 Pa·s, or less than about 580 Pa·s, or less than about 575 Pa·s, as determined by TPE-0200;

a moisture level of an undried neat pellet of from 0.05 wt % to 0.5 wt %, or 0.08 wt % to 0.4 wt %, or 0.1 wt % to 0.3 wt %, as determined by TPE-0111/3;

a 1% Secant flexural modulus @ 23° C. of about 40 MPa to about 200 MPa, or 50 MPa to about 150 MPa, or 60 MPa to about 100 MPa, as determined by ASTM D790 A; and

no breakage observation of extrudate at a sheet extrusion of the composition.

### Applications

The composition of the present disclosure can be particularly useful in making carpet backing, including an automobile carpet backing, or sometimes referred to as a heavy layer mat backing, and accordingly, in making carpet or heavy layer mat comprising such backings.

Typically, a carpet in the present disclosure comprises: (a) a primary backing layer which has a face and a back surface; (b) a plurality of fibers attached to the primary backing layer and extending from the face of the primary backing layer and exposed at the back surface of the primary backing layer; (c) a secondary backing layer comprising the composition of the present disclosure; and (d) and optional other layers, such as a reinforcing layer, adjacent to the secondary backing.

Any known methods of making a carpet can be used. For example, in one embodiment it comprises (a) providing a primary backing layer having a face and a back surface, with a plurality of fibers attached to the primary backing layer and extending from both the face and the back surface of the primary backing layer, (b) applying a secondary backing layer comprising the composition described herein to the back surface of the primary backing layer to lock in the plurality of fibers extending from the back surface of the primary backing layer, and (c) forming a carpet. Preferably the secondary backing layer is extruded to flow round the fibers extending from the back surface of the primary backing layer by sheet extrusion. More methods can be found in U.S. Patent Application Publication No. 2011/0256335 A1.

Materials of the fiber and the primary backing layers are not deemed critical to the present disclosure. Materials of the fiber includes, but are not limited to, polypropylene, nylon, wool, cotton, acrylic, polyester and polytrimethylenetheraphthalate (PTT). Materials of primary backing layer comprise a polyolefin, such as polypropylene, preferably a slit film polypropylene sheet, such as that sold by AMOCO or Synthetic Industries, or others, such as non-woven webs.

### EXAMPLES

### Materials

Vistamaxx™ 6202 is a propylene-based copolymer commercially available from ExxonMobil Chemical Company, TX, U.S., and has a MFR of 18 g/10 min (21.6 kg, 230° C.) and has an ethylene content of 15 wt % and a density of 0.863 g/cm³.

Vistamaxx™ 2330 is propylene-based copolymer commercially available from ExxonMobil Chemical Company, TX, U.S., and has a MFR of 285 g/10 min (21.6 kg, 230° C.) and a density of 0.868 g/cm³.

Exxelor™ 1020 is a maleic anhydride functionalized homopolypropylene commercially available from ExxonMobil Chemical Company, TX, U.S., and has a MFR of 430 g/10 min (21.6 kg, 230° C.).

Escorez™ 2203 is an aromatic modified aliphatic hydrocarbon tackifying resin commercially available from ExxonMobil Chemical Company, TX, U.S., and has a molecular weight Mw of about 2200 g/mol.

Wingtack 95 is a low molecular weight aliphatic resin based predominantly on C-5 monomers commercially available from Cray Valley USA, LLC, Exton, Pa., U.S., and has a molecular weight Mw of about 1700 g/mol.

Achieve™ 6936G1 PP is a homopolypropylene commercially available from ExxonMobil Chemical Company, TX, U.S., and has a MFR of 1550 g/10 min (21.6 kg, 230° C.).

Stearic Acid F1000 is a compatibilizer and commercially available from Harwick Standard Distribution Corporation, Akron, Ohio, U.S.

STRUKTOL TPW243 is a compatibilizer commercially available from Struktol Company of America, PA, U.S., it performs bonding function by free radical source through an ionic mechanism initiated by hydrolysis reaction.

PV20A fly ash filler is commercially available from B oral Material Technologies Inc., San Antonio, Tex., U.S.

CS325 ground glass filler is commercially available from Vitro Minerals, Covington, Ga., U.S.

### Testing Method

Some test methods used in the examples are shown as follows in Table 1.

TABLE 1
Test Methods

| Properties | Testing Method | Speed/Conditions |
|---|---|---|
| LCR Viscosity | TPE-0200 | 1/200 s |
| Moisture level | TPE-0111/3 | 500 mm/min, level of water is |
| of undried | | determined using a Computrac |
| neat pellets | | Vapor Pro Moisture Analyzer |
| Melt | Sheet Extrusion | Observation on break of extruded |
| Strength/ | Observation | sheet, qualitative rating with 0 being |
| Extrudability | | very poor and 5 being excellent |
| Flexural | ASTM D 790 A | |
| Modulus | | |

Formulations of samples 1 to 16 are shown in Table 2.

TABLE 2

| | | | | CS325 | | | | | | |
|---|---|---|---|---|---|---|---|---|---|---|
| | | | PV20A | Ground | Exxelor | Escorez | Wingtack | Achieve | | |
| | VM6202 | VM2330 | Fly ash | glass | 1020 | 2203 | 95 | 6936G1 | F1000 | TPW243 |
| Sample | (wt %) | (wt %) | (wt %) | (wt %) | (wt %) | (wt %) | (wt %) | (wt %) | (wt %) | (wt %) |
| 1 | 19 | 11 | 50 | 20 | 0 | 0 | 0 | 0 | 0 | 0 |
| 2 | 10 | 15 | 50 | 20 | 0 | 0 | 5 | 0 | 0 | 0 |
| 3 | 30 | 0 | 51.3 | 18.7 | 0 | 0 | 0 | 0 | 0 | 0 |
| 4 | 27.5 | 0 | 51.3 | 18.7 | 0 | 0 | 0 | 2.5 | 0 | 0 |
| 5 | 25 | 0 | 51.3 | 18.7 | 0 | 0 | 0 | 5 | 0 | 0 |
| 6 | 25 | 0 | 51.3 | 18.7 | 5 | 0 | 0 | 0 | 0 | 0 |
| 7 | 27 | 0 | 51.3 | 18.7 | 0 | 0 | 0 | 2.5 | 0.5 | 0 |
| 8 | 25 | 0 | 51.3 | 18.7 | 0 | 5 | 0 | 0 | 0 | 0 |
| 9 | 26 | 0 | 51.3 | 18.7 | 0 | 0 | 0 | 2.5 | 0 | 1.5 |
| 10 | 10 | 15 | 50 | 20 | 0 | 5 | 0 | 0 | 0 | 0 |
| 11 | 19 | 11 | 50 | 20 | 0 | 0 | 0 | 0 | 0 | 0 |
| 12 | 19 | 8 | 50 | 20 | 3 | 0 | 0 | 0 | 0 | 0 |
| 13 | 19 | 5 | 50 | 20 | 3 | 3 | 0 | 0 | 0 | 0 |
| 14 | 25.5 | 0 | 50 | 20 | 0 | 0 | 0 | 3 | 0 | 1.5 |
| 15 | 24.5 | 0 | 50 | 20 | 2 | 0 | 0 | 2 | 0 | 1.5 |
| 16 | 22.5 | 0 | 50 | 20 | 0 | 3 | 0 | 3 | 0 | 1.5 |
| 17 | 19 | 5 | 20 | 50 | 3 | 3 | 0 | 0 | 0 | 0 |
| 18 | 20.5 | 5 | 20 | 50 | 1.5 | 3 | 0 | 0 | 0 | 0 |
| 19 | 20 | 5 | 20 | 50 | 2 | 3 | 0 | 0 | 0 | 0 |
| 20 | 21 | 5 | 20 | 50 | 1 | 3 | 0 | 0 | 0 | 0 |
| 21 | 19 | 6.5 | 20 | 50 | 1.5 | 3 | 0 | 0 | 0 | 0 |
| 22 | 22.5 | 0 | 20 | 50 | 0 | 3 | 0 | 3 | 0 | 1.5 |
| 23 | 240 | 0 | 20 | 50 | 0 | 3 | 0 | 1.5 | 0 | 1.5 |
| 24 | 24.5 | 0 | 20 | 50 | 0 | 3 | 0 | 1 | 0 | 1.5 |
| 25 | 23.5 | 0 | 20 | 50 | 0 | 3 | 0 | 2 | 0 | 1.5 |
| 26 | 21 | 5 | 52.5 | 17.5 | 1 | 0 | 3 | 0 | 0 | 0 |
| 27 | 24 | 0 | 52.5 | 17.5 | 0 | 0 | 3 | 1.5 | 0 | 1.5 |

Compositions of Samples 1 to 9, 26, and 27 were compounded in a twin screw extruder. Some processing conditions for extrusion were as follows:

Feed: polymers and compatibilizer at feed throat, fly ash at barrel #5; and ground glass at barrel #7;

Barrel cooling water temperature: 35° C.;

Extruder RPM: 270 to 370 rpm;

Zone 1: 10° C.;

Zone 2-3: 90-150° C.;

Zone 4-5: 180-250° C.;

Zone 6-10: 150-200° C.;

Die temperature set point: 250-320° C.;

Die hole: 24;

Pelletizer water temperature: 30-50° C.

Compositions of Samples 10 to 25 were compounded in a Brabender mixer. All components were introduced in the preheated Brabender mixer and mixed at a RPM of about 100 at a mixing temperature of about 230° C. for about 3 to 5 minutes.

Properties of the compositions of Samples 1 to 27 were tested and shown in Table 3.

TABLE 3

| | LCR | Moisture | | | Flexural |
|---|---|---|---|---|---|
| | Viscosity | level of | Melt | extrud- | Modulus |
| | @ 1/200 s | undried neat | Strength | ability | (1% Sec |
| Sample | (Pa*s) | pellets | (0-5) | (0-5) | @23° C.) |
| 1 | 577 | 0.31 | 3 | 3 | 68.2 |
| 2 | 319.7 | 0.09 | 3.5 | 3 | 42.9 |
| 3 | 1228 | 0.37 | 0 | 1 | n/a |
| 4 | 904.3 | 0.2 | 1 | 1 | n/a |
| 5 | 705.1 | 0.15 | 3 | 2 | n/a |
| 6 | 994.7 | 0.05 | 2 | 3 | n/a |
| 7 | 700.4 | 0.55 | 0 | 1 | n/a |
| 8 | 646 | 0.32 | 1.5 | 2 | n/a |
| 9 | 571.6 | 0.17 | 5 | 5 | n/a |
| 10 | 255.9 | n/a | n/a | n/a | 48.3 |
| 11 | 594.2 | n/a | n/a | n/a | 73.3 |
| 12 | 559.1 | n/a | n/a | n/a | 143.9 |
| 13 | 435.6 | n/a | n/a | n/a | 104.9 |
| 14 | 441.7 | n/a | n/a | n/a | 92 |
| 15 | 549.8 | n/a | n/a | n/a | 160.6 |
| 16 | 424.5 | n/a | n/a | n/a | 82 |
| 17 | 522.7 | n/a | n/a | n/a | 84.8 |
| 18 | 525.5 | n/a | n/a | n/a | 55.4 |
| 19 | 607.4 | n/a | n/a | n/a | 50.7 |
| 20 | 589.4 | n/a | n/a | n/a | 57.7 |
| 21 | 473.3 | n/a | n/a | n/a | 76.2 |
| 22 | 388.8 | n/a | n/a | n/a | 60.7 |
| 23 | 308.6 | n/a | n/a | n/a | 43.3 |
| 24 | 461.9 | n/a | n/a | n/a | 41.3 |
| 25 | 436.3 | n/a | n/a | n/a | 53.4 |
| 26 | n/a | 0.093 | 4.5 | 3.5 | n/a |
| 27 | n/a | n/a | 5 | 5 | n/a |

As illustrated in Tables 2 and 3, Sample 9, in which the composition comprised the compatibilizer that provided a free radical source (Struktol TPW243), resulted in a moisture level of 0.17 wt %, a melt strength of 5 and an extrudability of 5, whereas Sample 7, in which the composition comprised a normal compatibilizer, resulted in a moisture level of 0.55 wt %, a melt strength of 0 and an extrudability of 1. Additionally, the viscosity of composition of Sample 9 was lower than Sample 7.

As illustrated in Tables 2 and 3, Sample 9, in which the composition comprised a compatibilizer that provided free radical sources (Struktol TPW243), resulted in a viscosity of 571.6 Pa*s, a melt strength of 5, and an extrudability of 5, whereas Sample 4, in which the composition comprised high flow second polymer component but did not comprise a compatibilizer, resulted in viscosity of 904.3 Pa*s, the melt strength of 1 and extrudability of 1.

As illustrated in Tables 2 and 3, Sample 27, in which the composition comprised 1.5 wt % the compatibilizer that provided free radical sources (Struktol TPW243), resulted in a melt strength of 5 and an extrudability of 5, whereas Sample 26, in which the composition comprised 9 wt % of a high flow second polymer component but did not comprise the compatibilizer, resulted in a melt strength of 4.5 and an extrudability of 3.5.

Also as illustrated in Tables 2 and 3, samples in which the composition comprised the compatibilizer that provided free radical sources resulted in good performance in flexural modulus.

Having described the various aspects of the present invention herein, further specific embodiments of the invention include those set forth below:

### Embodiment A

A composition, comprising:

(a) about 10 wt % to about 50 wt % of a first polymer component comprising an elastomeric copolymer;
(b) about 50 wt % to about 90 wt % of a filler by weight of the composition; and
(c) about 0.1 wt % to about 5 wt % of a compatibilizer by weight of the composition, the compatibilizer providing free radical source to bond the first polymer component and the filler.

### Embodiment B

The composition of Embodiment A, wherein the compatibilizer provides free radical source by hydrolysis reaction.

### Embodiment C

The composition of any of the preceding embodiments, wherein the compatibilizer has a melting point of about 50° C. to about 120° C.

### Embodiment D

The composition of any of the preceding embodiments, wherein the compatibilizer has a flash point of about 150° C. to about 300° C.

### Embodiment E

The composition of any of the preceding embodiments, wherein the compatibilizer has a specific gravity of about 0.9 g/cm³ to about 1 g/cm³.

### Embodiment F

The composition of any of the preceding embodiments, wherein the compatibilizer is present in an amount of from about 1 wt % to about 3 wt %.

### Embodiment G

The composition of any of the preceding embodiments, wherein the filler is fly ash, ground glass, calcium carbonate, talc, clay, or combinations thereof.

### Embodiment H

The composition of any of the preceding embodiments, wherein the filler is present in an amount of from about 70 wt % to about 75 wt % by weight of the composition.

### Embodiment I

The composition of any of the preceding embodiments, wherein the first polymer component has a melting temperature of less than 110° C.

### Embodiment J

The composition of any of the preceding embodiments, wherein the first polymer component is a propylene-based copolymer having about 60 wt % to about 98 wt %, preferably about 75 wt % to about 95 wt %, propylene-derived units and about 2 wt % to about 40 wt %, preferably about 5 wt % to about 25 wt %, units derived from at least one of ethylene or a C₄-C₁₂ alpha-olefin by weight of the propylene-based copolymer.

### Embodiment K

The composition of Embodiment J, wherein the propylene-based copolymer has a heat of fusion, as determined by DSC, of about 75 J/g or less.

### Embodiment L

The composition of Embodiment J or K, wherein the propylene-based copolymer has a density of from about 0.850 g/cm³ to about 0.915 g/cm³.

### Embodiment M

The composition of any of Embodiments J to L, wherein the propylene-based copolymer has a melt flow rate, as determined at 230° C. and 2.16 kg weight, of about 200 g/10 min or less.

### Embodiment N

The composition of any of the preceding embodiments, wherein the first polymer component comprises a propylene-ethylene copolymer, propylene-butene copolymer, propylene-octene copolymer, or combinations thereof.

### Embodiment O

The composition of any of Embodiments A to I, wherein the first polymer component is an ethylene-based copolymer having about 60 wt % to about 98 wt %, preferably about 70 wt % to about 95 wt %, ethylene-derived units and about 2 wt % to about 40 wt %, preferably about 5 wt % to about 30 wt %, units derived from C₃-C₁₂ alpha-olefin.

### Embodiment P

The composition of Embodiment O, wherein the ethylene-based copolymer has a melt index, as determined at 190° C. and 2.1 kg, of less than about 30 g/10 min.

### Embodiment Q

The composition of Embodiment O or P, wherein the ethylene-based copolymer has a density of from about 0.850 g/cm³ to about 0.915 g/cm³.

### Embodiment R

The composition of any of Embodiments A to I or O to Q, wherein the first polymer component comprises an ethylene-butylene copolymer, ethylene-hexene copolymer, ethylene-octene copolymer, or combinations thereof.

### Embodiment S

The composition of any of Embodiments A to R, wherein the composition further comprises about 0.1 wt % to about 10 wt % of a second polymer component by weight of the composition, where the second polymer component has a melt flow weight, as determined by 230° C. and 2.16 kg weight, of about 10 g/10 min or greater.

### Embodiment T

The composition of any of Embodiments A to R further comprising about 0.1 wt % to about 10 wt % of a second polymer component by weight of the composition, the second polymer component has a melt flow rate, as determined at 230° C. and 2.16 kg weight, of about 250 g/10 min or greater, and the first polymer component has melt flow rate of about 200 g/10 min or less.

### Embodiment U

The composition of Embodiment T, wherein the second polymer component comprises a hydrocarbon tackifying resin.

### Embodiment V

The composition of any one of Embodiments S to U, wherein the second polymer component is present in an amount of from about 0.1 wt % to about 5 wt %.

### Embodiment W

The composition of any of the preceding embodiments further comprising a paraffinic oil, a napthenic oil, a PAO fluid, or combination thereof.

### Embodiment X

The composition of any of the preceding embodiments further comprising a maleic anhydride functionalized EVA.

### Embodiment Y

A composition comprising: (a) about 10 wt % to about 50 wt % of a first polymer component by weight of the composition, the first polymer component comprising an elastomeric copolymer; (b) about 65 wt % to about 85 wt % of a filler by weight of the composition; (c) about 0.1 wt % to about 10 wt % of a second polymer component by weight of the composition, the second polymer component having a melt flow rate, determined at 230° C. and 2.16 kg weight, of about 250 g/10 min or greater; and (d) about 0.1 wt % to about 3 wt % of a compatibilizer providing free radical source by hydrolysis reaction to bond the polymer components and the filler, by weight of the composition.

### Embodiment Z

The composition of any of the preceding embodiments having a viscosity of less than about 700 Pa*s, as determined by TPE-0200 at 1/200 sec.

### Embodiment AA

The composition of any of the preceding embodiments having a flexural modulus at 1% secant flexural modulus of from about 40 MPa to about 200 MPa, as determined by ASTM D790 A at 23° C.

### Embodiment AB

The composition of any of the preceding embodiments having a moisture level of an undried neat pellet of about 0.1 to about 0.5 wt %, determined by TPE-0111/3.

### Embodiment AC

A carpet backing comprising a composition of any of Embodiments A to AB.

### Embodiment AD

A carpet comprising the carpet backing of Embodiment AC.

### Embodiment AE

A carpet comprising: (a) a primary backing layer which has a face and a back surface; (b) a plurality of fibers attached to the primary backing layer and extending from the face of the primary backing layer and exposed at the back surface of the primary backing layer; and (c) a secondary backing layer comprising a carpet backing composition, wherein the carpet backing composition comprises the composition of any of Embodiments A to AB.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

The foregoing description of the disclosure illustrates and describes the present disclosure. Additionally, the disclosure shows and describes only the preferred embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

What is claimed is:

1. A carpet backing composition comprising:
(a) about 10 wt % to about 50 wt % of a first polymer component by weight of the composition, the first polymer component comprising an elastomeric polymer;
(b) about 50 wt % to about 90 wt % of a filler by weight of the composition; and
(c) about 0.1 wt % to about 5 wt % of a compatibilizer by weight of the composition, the compatibilizer providing free radical source to bond the first polymer component and the filler.

2. The composition of claim 1, wherein the compatibilizer has a melting point of about 50° C. to about 120° C.

3. The composition of claim 1, wherein the compatibilizer has a flash point of about 150° C. to about 300° C.

4. The composition of claim 1, wherein the compatibilizer has a specific gravity of about 0.9 g/cm³ to about 1 g/cm³.

5. The composition of claim 1, wherein the compatibilizer is present in an amount of from about 1 wt % to about 3 wt %.

6. The composition of claim 1, wherein the filler comprises fly ash, ground glass, calcium carbonate, talc, clay, or combinations thereof.

7. The composition of claim 1, wherein the filler is present in an amount of from about 70 wt % to about 75 wt % by weight of the composition.

8. The composition of claim 1, wherein the first polymer component has a melting temperature of less than about 110° C.

9. The composition of claim 1, wherein the first polymer component is a propylene-based copolymer having about 75 wt % to about 95 wt % propylene-derived units and about 5 wt % to about 25 wt % units derived from at least one of ethylene or a C₄-C₁₂ alpha-olefin by weight of the propylene-based copolymer, and the propylene-based copolymer having a heat of fusion, as determined by DSC, of about 75 J/g or less.

10. The composition of claim 9, wherein the propylene-based copolymer has a melt flow rate, as determined at 230° C. and 2.16 kg weight, of about 200 g/10 min or less.

11. The composition of claim 9, wherein the propylene-based copolymer is propylene-ethylene copolymer, propylene-butene copolymer, propylene-octene copolymer, or combinations thereof.

12. The composition of claim 1, wherein the first polymer component is an ethylene-based copolymer having about 70 wt % to about 95 wt % ethylene-derived units and about 5 wt % to about 30 wt % units derived from C₃-C₁₂ alpha-olefin, and the ethylene-based copolymer has a melt index, as determined at 190° C. and 2.16 kg, of less than about 30 g/10 min.

13. The composition of claim 1 further comprising about 0.1 wt % to about 10 wt % of a second polymer component by weight of the composition, where the second polymer component has a melt flow weight, as determined by 230° C. and 2.16 kg weight, of about 10 g/10 min or greater.

14. The composition of claim 1 further comprising about 0.1 wt % to about 10 wt % of a second polymer component by weight of the composition, the second polymer component has a melt flow rate, as determined at 230° C. and 2.16 kg weight, of about 250 g/10 min or greater, and the first polymer component has melt flow rate of about 200 g/10 min, or less.

15. The composition of claim 14, wherein the second polymer component comprises a hydrocarbon tackifying resin.

16. The composition of claim 13, wherein the second polymer component is present in an amount of from about 0.1 wt % to about 5 wt % by weight of the composition.

17. The composition of claim 1 further comprising a paraffinic oil, a napthenic oil, a PAO fluid, or combinations thereof.

18. The composition of claim 1 further comprising a maleic anhydride functionalized EVA.

19. A composition comprising:
(a) about 10 wt % to about 50 wt % of a first polymer component by weight of the composition, the first polymer component comprising an elastomeric polymer;
(b) about 65 wt % to about 85 wt % of a filler by weight of the composition;
(c) about 0.1 wt % to about 10 wt % of a second polymer component by weight of the composition, the second polymer component having a melt flow rate, determined at 230° C. and 2.16 kg weight, of about 250 g/10 min or greater; and
(d) about 0.1 wt % to about 3 wt % of a compatibilizer providing free radical source by hydrolysis reaction to bond the polymer components and the filler, by weight of the composition.

20. The composition of claim 1, wherein the composition has a viscosity of about 700 Pa*s or less, as determined by TPE-0200 at 1/200 sec.

21. The composition of claim 1, wherein the composition has a flexural modulus at 1% secant flexural modulus of from about 40 MPa to about 200 MPa, as determined by ASTM D790 A at 23° C.

22. The composition of claim 1, wherein the composition has a moisture level of an undried neat pellet of about 0.1 to about 0.5 wt %, determined by TPE-0111/3.

23. A carpet backing comprising the composition of claim 1.

24. A carpet comprising:
(a) a primary backing layer which has a face and a back surface;
(b) a plurality of fibers attached to the primary backing layer and extending from the face of the primary backing layer and exposed at the back surface of the primary backing layer; and
(c) a secondary backing layer comprising a carpet backing composition,
wherein the carpet backing composition comprising:
(i) about 10 wt % to about 50 wt % of a first polymer component by weight of the composition, the first polymer component comprising an elastomeric polymer;
(ii) about 50 wt % to about 90 wt % of a filler by weight of the composition; and
(iii) about 0.1 wt % to about 5 wt % of a compatibilizer by weight of the composition, the compatibilizer providing free radical source to bond the first polymer component and the filler.
